(19) United States
(12) Patent Application Publication
(10) Pub. No.: US 2004/0215834 A1
(43) Pub. Date: Oct. 28, 2004

(54) Method of testing connecting port of printers and fixture thereof

(76) Inventors: Win-Harn Liu, Taipei (TW); Jeff Song, Taipei (TW); Zhen Wang, Tianjin (CN); Chiu-Yue Duan, Tianjin (CN)

Correspondence Address: BIRCH STEWART KOLASCH & BIRCH, PO BOX 747, FALLS CHURCH, VA, 22040-0747, US

(21) Appl. No.: 10/420,848

(22) Filed: Apr. 23, 2003

(51) Int. Cl. G06F 3/00

(52) U.S. Cl. 710/1

(57) ABSTRACT

A testing fixture and method for printer ports to test whether data transmission is regular between the data signal pins, the status signal pins and the control signal pins. The method of the invention involves connecting the data signal pins to one of the status signal pins and connecting a plurality of diodes therebetween. The control signal pins and the remaining status signal pins are then connected, and the voltage level of the connected pins is checked to verify that the pins of the printer port are regular.

### FIELD OF THE INVENTION

The invention relates to a testing method for printer connector ports and testing fixture thereof, and more specifically to a testing method of the extended capabilities port of printers and testing fixture thereof.

### BACKGROUND OF THE INVENTION

In most computers, the Serial Port (COM Port) and Parallel Port are used to communicate with the peripheral devices. Since the Parallel Port is usually used to connect printers, it is also known as the Line Printer Port (LPT Port). The Parallel Port, which transmits 8 bits of data at a time, is much faster than the Serial Port, which only transmits 1 bit at a time. However, the Parallel Port is generally used for short distance data transmission because of the need of increasing data lines. Therefore, the Line Printer Port can also be used to transmit data between two computers for short distance purposes. Generally, there are twenty-five pins in a printer port. Seventeen of these (except 8 grounds, PIN 18˜PIN 25) are defined as follows:

1. Input pins: including five STATUS signal pins, ACK (PIN 10), BUSY (PIN 11), PE (PIN 12), SLCT (PIN 13), and ERROR (PIN 15). The five STATUS signal pins are used to input STATUS signals to computers.

2. Output pins: including four CONTROL signal pins, STROBE (PIN 17), AUTOFD (PIN 14), INT (PIN 16), SCLTIN (PIN 17). The four CONTROL signal pins are used to output control signals from computers.

3. Input/Output pins: including eight data pins, D0 (PIN 2), D1 (PIN 3), D2 (PIN 4), D3 (PIN 5), D4 (PIN 6), D5 (PIN 7), D6 (PIN 8), D7 (PIN 9). The right pins are used to receive data from and transmit data to computers.

The traditional testing method involves outputting a signal from the output pins to the input pins. If the voltage level of the output signal of the output pin is equal to the voltage level of the input signal of the input pin, then there is no open circuit between input and output pins. However, we can only test ten out of seventeen pins using the traditional method. The remaining pins are not testable. The traditional method also has the following disadvantages:

1. When a short circuit between D5 (or D7) and the ground, D5 (or D7) is undetectable.

2. When a short circuit between any two pins from D0 to D7, the pinsis undetectable.

3. When a short circuit between ACK and BUSY, the two pins is undetectable.

Therefore, testing departments for printer ports have provided a variety of solutions to improve the testing coverage. For example, a testing method as shown in FIG. 1 has been disclosed. The method involves connecting PIN 2 (D0) and PIN 15. The voltage level of the pins is then pulled high or low repeatedly. If the voltage levels of the two pins are the same, then data is transmitted from PIN 2 properly. Therefore, we can test all pins by connecting PIN 15 to D0˜D7 in turn. However, it is inefficient to test only one pin at a time.

Another testing fixture shown in FIG. 2 has been disclosed to solve the above-mentioned drawbacks. The testing method involves connecting a pull down resistor 23 and a diode 27. Not only are the seventeen pins tested simultaneously, but the efficiency of the testing process is also improved. The pull down resistor 26 is employed to assure that the voltage level read from PIN 15 is low when the voltage level of the data lines is low. The testing process starts by pulling the voltage levels of PINS 2 to 9 (D0 to D7) low. Then we check whether the voltage level of PIN 15 is low. If not, the printer port is not working regularly to transmit data because one of PINS 2 to 9 is malfunctioning. If the voltage level of PIN 15 is high, then we pull the voltage level of one of the PINS 2 to 9 high, then check whether the voltage level of PIN 15 is high. If the voltage level of PIN 15 is not high, the printer connector is not working regularly. If the voltage level of PIN 15 is high, then the printer connector is transmitting data regularly. The testing process then continues repeatedly until all the pins are checked. Unfortunately, one drawback still exists. The value of the pull down resistor varies in different testing situations. The incorrect value of the pull down resistor leads to incorrect testing results. Furthermore, adjusting the pull down resistor makes the testing process complicated. Therefore, a solution to improve testing efficiency and to simplify the testing procedure is necessary.

### SUMMARY OF THE INVENTION

The main object of the invention is to provide a testing method of extended capability printer ports and fixture thereof to solve the above-mentioned problems, improve testing efficiency and simplify the testing procedure.

The method of the invention involves connecting the data pins to one of the four status signal pins (D0˜D3), and connecting a plurality of diodes in parallel therebetween. The control signal pins are connected to the remaining status signal pins. Then the voltage level of the connected pins is checked to determine whether the pins are regular.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 illustrates the traditional testing fixture.

FIG. 2 illustrates the traditional testing fixture.

FIG. 3 illustrates the connection of the pins of the testing fixture of the invention.

FIG. 4 illustrates the flow chart of the invention.

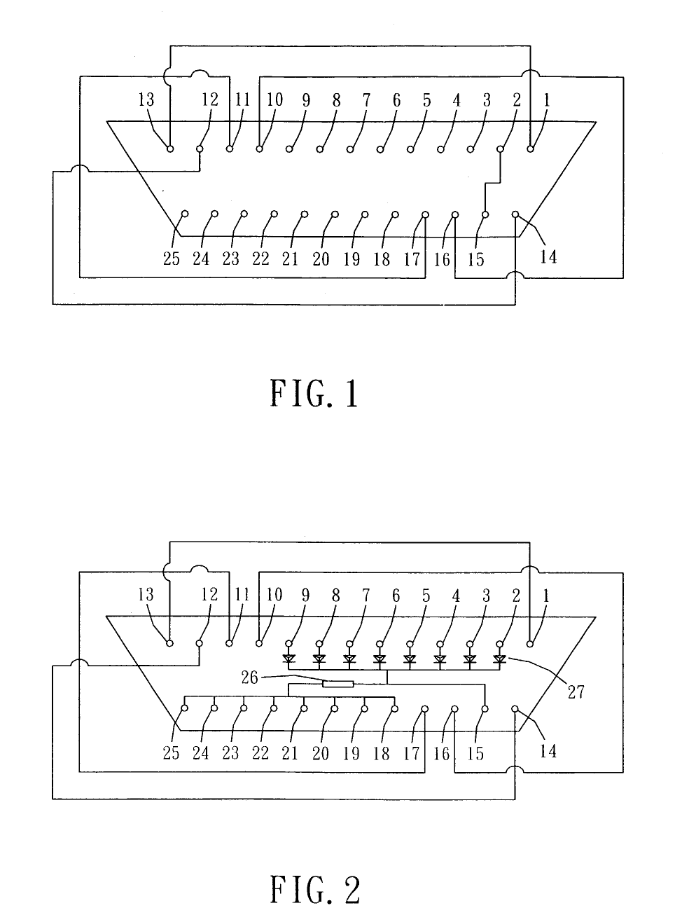

### DETAILED DESCRIPTION OF THE INVENTION

The object of the testing fixture of the invention is to test whether data transmission is regular between the data signal pins, and the status signal pins and the control signal pins. The method of the invention involves connecting the data signal pins to one of the status signal pins and connecting a plurality of diodes in parallel between each of the data signal pins and the status pins. The control signal pins are connected to the remaining status signal pins. Then the voltage level of the connected pins is checked to determine the status of the printer port.

Generally, there are twenty-five pins in a printer port. Seventeen of these (except 8 grounds, PIN 18˜PIN 25) are defined as follows:

1. Input pins: including five STATUS signal pins, ACK (PIN 10), BUSY (PIN 11), PE (PIN 12), SLCT (PIN 13), and ERROR (PIN 15). The five STATUS signal pins are used to input STATUS signals to computers.

2. Output pins: including four CONTROL signal pins, STROBE (PIN 17), AUTOFD (PIN 14), INT (PIN 16), and SCLTIN (PIN 17). The four CONTROL signal pins are used to output control signals from computers.

3. Input/Output pins: including eight data pins, D0 (PIN 2), D1 (PIN 3), D2 (PIN 4), D3 (PIN 5), D4 (PIN 6), D5 (PIN 7), D6 (PIN 8), and D7 (PIN 9). The right pins are used to receive data from and transmit data to computers.

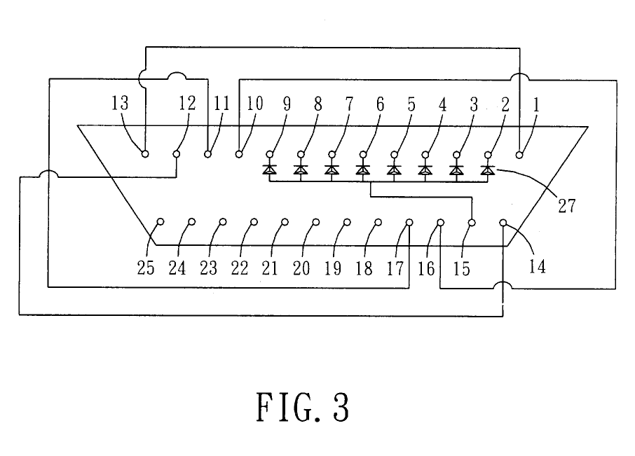

FIG. 3 illustrates the testing fixture of the invention. The input pins (status pins including PIN 10 to PIN 13) are connected to the output pins (control pins including PIN 1, PIN 14, PIN 16 and PIN 17). The regularity of the pins is checked by assigning a voltage level to the input pins and checking whether the voltage level of the input pins and the output pins is the same. There are five status pins and four control signal pins, so one status signal pin remains. The eight data pins (PIN2 to PIN 9) are connected to PIN 15. There are eight diodes 27 connected in parallel between each of PINS 2 to 9 and PIN 15. The data signal pins are checked by the voltage level of PIN 15. The design of the invention solves the problem of testing coverage. The problems of pairing the pins and adjusting the value of the resistor are also solved by the method of the invention. By just placing the printer port on the fixture of the invention, the status of the printer port can be seen on the computer screen.

As illustrated in FIG. 3, the method of the invention involves connecting PIN13 (SLCT) and PIN1 (STROBE), PIN14 (AUTOFD) and PIN12 (PE), PIN10 (ACK) and PIN16 (NIT), PIN11 (BUSY) and PIN17 (SCLTIN), and PIN2 to PIN9 (D0˜D7) to PIN15 (ERROR). A plurality of diodes 27 is connected between each of PINS 2 to 9 and PIN 15. The P pole of the diode 27 is connected to PIN 15 (ERROR). The N pole of the diode 27 is connected to PINS 2 to 9. The diode solves the problem of the broken circuit between the data signal pins and the ERROR pin, as well as the need to tune the value of the resistor.

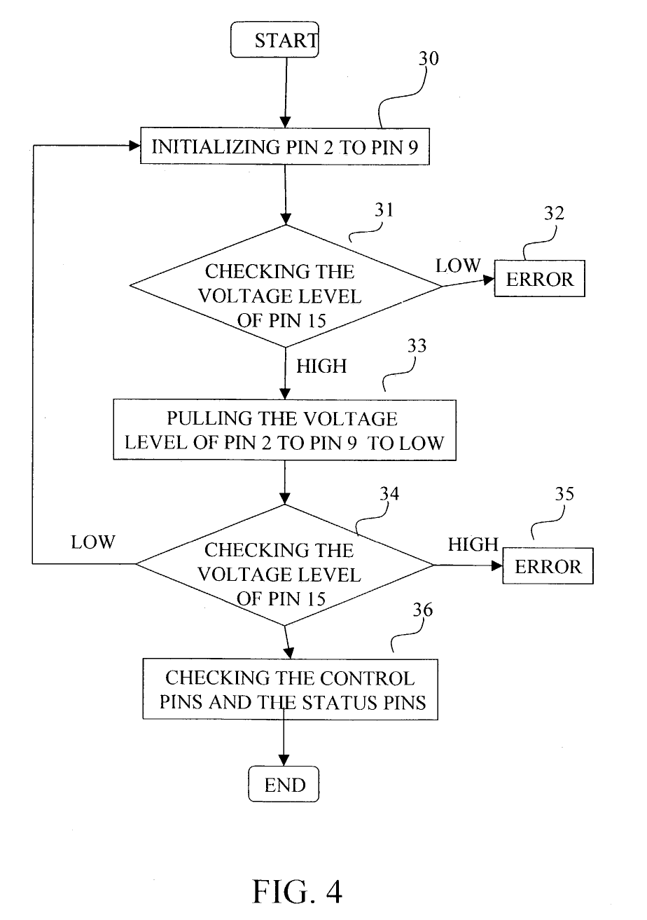

Please refer to FIG. 4, which illustrates the testing flow of the invention. First, PINS 2 to 9 and the testing fixture are initialized to prevent the computer from crashing (Step 30). The computer sends an initial signal to the data signal pins to pull the voltage level of PINS 2 to 9 to high (Logic 1). Then it checks whether the voltage level of PIN 15 (ERROR) is high (Logic 1). If the voltage level is low, then an error message is displayed (Steps 31 and 32). If the voltage level is high, then a testing signal is sent to the data signal pins, i.e., pulling the voltage level of one of PINS 2 to 9 to low (logic 0). Then it checks whether the voltage level of PIN 15 (ERROR) is low (Logic 0). If the voltage level is low, data transmission between the pin pulled to low and PIN 15 is regular. Otherwise the printer port is malfunctioning (Steps 33 and 35).

After checking one of PINS D0 to D7, we continue the above testing steps to test the other seven pins. The testing signal is only sent to one of PINS D0 to D7, rather than to all of the pins. Otherwise, the testing fixture works irregularly. Assigning the voltage level and checking the voltage level are achieved by the computer and the register on the testing fixture. The testing signal is only sent to one of PINS D0 to D7 because PINS 2 to 9 (D0˜D7) are all connected to PIN 15 (ERROR). If the voltage level of the pins is pulled to low, the register and the computer make incorrect judgments. Therefore, the testing signal is sent to only one of the pins at a time.

After checking PINS 2 to 9, we continue checking the other pins including PIN 13 (SLCT) and PIN 1(STROBE), PIN 14(AUTOFD) and PIN 12(PE), PIN 10(ACK) and PIN 16(INIT), and PIN 11 (BUSY) and PIN 17(SCLTIN) (Step 36).

The pin connection and testing procedure are achieved by the diode after repeated measurement and experiment. The problem of pairing the pins is solved and the all of the pins are tested. Only one fixture is needed to test the printer port. The cost, the quantity of Producing fixture, and the working hours of the testing fixture are greatly reduced. The testing coverage is improved and the yield rate is higher. Furthermore, all of the pins are checked.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A testing fixture of printer port for testing if the data transmission is regular among the data signal pins, the status signal pins and the control signal pins, which is characterized by:
connecting the data signal pins to one of the status signal pins and connecting a plurality of diodes therebetween, connecting the control signal pins and the remaining status signal pins, and then checking the voltage level of the connected pins to verify if the pins of the printer port is regular.

2. The testing fixture of claim 1, wherein the data signal pins are connected to the ERROR pin of the status signal pins.

3. The testing fixture of claim 1, wherein the P pole of the diodes is connected to the status signal pins, and the N pole of the diodes is connected to the data signal pins.

4. A method of printer port for testing if the data transmission is regular among the data signal pins comprising the steps of:
connecting the data signal pins to one of the status signal pins and connecting a plurality of diodes therebetween;
connecting the control signal pins and the remaining status signal pins;
sending an initial signal to the data signal pins;
reading the signal from the status signal pin connected to the data signal pins and comparing the read signal with the initial signal to verify if initializing is completed;
sending a testing signal to the data signal pins; and
reading the signal from the status signal pin connected to the data signal pins and comparing the read signal with the testing signal to check the status of the data signal pins.

5. The method of claim 4, wherein the data signal pins are connected to the ERROR pin of the status signal pins.

6. The method of claim 4, wherein the P pole of the diodes is connected to the status signal pins, and the N pole of the diodes is connected to the data signal pins.

7. The method of claim 4, wherein the initial signal is logic 1 (high voltage level).

8. The method of claim 4, wherein the testing signal is logic 0 (low voltage level).

9. The method of claim 4, wherein the testing signal is sent to only one of the data signal pins.
